(19) United States
(12) Patent Application Publication
(10) Pub. No.: US 2009/0092709 A1
(43) Pub. Date: Apr. 9, 2009

(54) CLEAR FILTERED NUTRITIONAL SUPPLEMENT BEVERAGE AND FILTRATION METHOD

(75) Inventor: Stewart Irving, Oakland, CA (US)

Correspondence Address: FOLEY & LARDNER LLP, 111 HUNTINGTON AVENUE, 26TH FLOOR, BOSTON, MA, 02199-7610, US

(73) Assignee: Joint Juice, Inc.

(21) Appl. No.: 11/866,466

(22) Filed: Oct. 3, 2007

(51) Int. Cl. A23L 2/00; A23L 2/72

(52) U.S. Cl. 426/66; 426/330.3; 426/490

(57) ABSTRACT

The present invention provides a dietary supplement, and method for making the same, comprising a glucosamine-based beverage that has the physical appearance of water, or that otherwise appears substantially transparent in its final form. The method for making the glucosamine-based beverage includes passing an aqueous glucosamine-containing solution through a multiple-step filtration process at a predetermined pH level. The first filtration step is performed with a porous volumetric fiber matrix, which is a Nominal rated filter with a cut off in the range of 0.5-1.2 microns, and preferably 0.5 microns, and at a cross-filter pressure less than or equal to 10 psi. The second filtration step is performed with a membrane filter, which is an Absolute rated filter with a cut off in the range 0.3-0.6 microns, and preferably 0.45 microns, and at a cross-filter pressure less than or equal to 10 psi.

### FIELD OF THE INVENTION

The present invention relates to beverages, filtered to remove coloring particles, and fortified with one or more joint function enhancing supplements.

### BACKGROUND

Ready-to-drink nutritional and dietary supplements are convenient and popular, particularly for those persons too busy to eat regular meals and for hikers, cyclists, runners or other athletes who need prepackaged, ready-to-eat, high-energy snacks while they are exercising. Additionally, such supplements can supply consumers with the necessary vitamins and minerals specified in the recommended daily allowances provided by the U.S. government.

Drinks formulations and methods for preparing them have also been developed. Energy enhancement drinks and processes have been developed such as in U.S. Pat. No. 3,894,148, which relates to nutritional and exercise therapy to maximize the storage of glycogen in muscle tissue. Protein fortification drinks have been described in U.S. Pat. No. 4,309,417. Finally, carbohydrate and electrolyte drinks have been described in U.S. Pat. Nos. 4,312,856 and 4,322,407.

More recently, joint function enhancing dietary supplements, including beverages containing glucosamine chondroitin sulfate, and hyaluronic acid have been described in U.S. Pat. Nos. 6,391,864 (Stone) and 6,432,929 (Stone). Although these patents describe beverages that include dietary supplements, the resulting beverages are cloudy with particulates and other coloration from the beverage ingredients. Neither of the patents describe a clear beverage, nor a method for achieving a clear, translucent, or transparent beverage containing dietary supplements.

Although there are several nutritional supplement beverages on the market that include vitamins or flavoring, none of the producers of such products have been able to produce a clear, colorless product that includes glucosamine.

It is therefore one object of this invention to provide a formula which provides a transparent beverage, with the appearance of water, that contains one or more dietary supplements, such as glucosamine, and preferably, glucosamine hydrochloride.

Yet another object of the invention is to provide a method of preparing a beverage containing one or more joint function enhancing supplements that has an essentially clear, and preferably colorless, appearance.

### SUMMARY OF THE INVENTION

The present invention provides a dietary supplement beverage that has the physical appearance of water, or that otherwise appears transparent in its final form. The beverage may include a number of supplements, including glucosamine. It may also include other supplements, such as chondroitin sulfate, and vitamins. The beverage has an essentially transparent appearance at ambient temperature.

In all beverages that embody the present invention, the glucosamine, as well as other supplements, to the extent that each is included in the final beverage, is pre-filtered using a two-step filtration process at a predetermined pH level. The resulting beverage is clear, and typically has a shelf-life that exceeds 6 months at ambient temperature, or that exceeds 12 months when maintained at a temperature of less than 5° C.

The method for achieving such a glucosamine-based beverage includes passing an aqueous glucosamine-containing matrix through a multiple-step filtration process at a predetermined pH level, in the range 1.5-3.5, at a temperature in the range 2-30° C. In the preferred form of the invention, two filtration steps are used, although fewer or additional filtration steps may be used in other embodiments. The first step of the filtration process includes passing the supplement through a Nominal rated first filter having a cut off in the range of 0.2-1.2 microns, and preferably 0.5 microns. The Nominal rated filter is preferably a volumetric fiber matrix, effective to remove approximately 90% of the particles above the rated cut off. This filter allows a relatively long operational period before requiring replacement due to clogging. This filter makes a “rough cut” for large quantities of product and is suitable for a commercial process. This step preferably is performed at a cross-filter pressure less than or equal to 10 psi.

The first filtration step is followed by the second step of passing the first glucosamine filtrate from the first step, through an Absolute rated second filter having a cut off in the range 0.3-0.6 microns, and preferably 0.45 microns. The Absolute rated filter is preferably a membrane filter with a pore structure adapted to remove more than 99.9% of the particulates above the rated cutoff. This step preferably is performed at a cross-filter pressure less than or equal to 15 psi, The second step forms a second glucosamine filtrate, which is clear, void of suspended particulates and with reduced or no coloration. The final nutritional supplement beverage preferably is formed by mixing the second glucosamine filtrate with additional liquid at ambient temperature in the range of 2-30° C. The latter step preferably is performed at a pH of in the range 2.5-4.0.

### DETAILED DESCRIPTION OF THE INVENTION

Nutritional supplement beverages of the present invention preferably have a water base, or may include multiple ingredients obtained from other commercially available beverage “sports drink” beverages. Such “sports drinks” may provide calories substantially only in the form of carbohydrates and provide electrolyte replacements, which are thought to aid in recovery after exercise, However, the present beverage may also, or alternatively, include multiple vitamins, single vitamins, or antioxidants, in combination with glucosamine (either in hydrochloride form (HCl) or sulfate form) in a water base. The beverage preferably is non-carbonated, but alternatively, may be carbonated. In a preferred embodiment, glucosamine HCl is mixed in filtered water at ambient temperature (for example, in a range 10-24° C.), prior to filtration in accordance with the present invention.

The nutritional supplement beverage of the present invention preferably includes an amount of glucosamine HCl and has been filtered as described below. Prior to filtration, the glucosamine HCl solution is typically cloudy and contains contaminants contributing to discoloration, generally in the form of resident particulates. If the resident particulates remain in the glucosamine solution, they typically bind to other particulates during the formulation process, causing the final beverage to have one or more of the following undesirable qualities: yellow or unclear color tone, clouding, or visible particulate formation, After the filtration of the present invention the filtered glucosamine can be added to supplemented water, or vitamin supplemented clear beverages while retaining a clear, transparent coloration or is substantially colorless.

Because the beverage of the present invention has impurities removed, the taste of the beverage is improved over those products that do not have multiply-filtered glucosamine. The filtration removes residual particulates that typically cause other impurities, or constituents, to bind and remain in the beverage, Thus, the beverage of the present invention not only has visual transparency and is colorless, but also has improved taste over other products. In a preferred embodiment, the glucosamine HCl is a fermentation-derived glucosamine, and not derived from shellfish. This makes the beverage of the present invention safe for those consumers having a shellfish allergy. In some forms of the invention, the glucosamine is shellfish-based.

Removal of particulates and contaminates associated with the glucosamine potentially improves the shelf-life of the beverage. The beverage may be stored at room temperature for at least 6 months or stored in refrigeration for at least 12 months, without deleterious effects. The removal of particulates in accordance with the inventive process also reduces the potential for bacterial growth and formation of undesirable particulates and other residues, resulting in improved appearance and taste,

The beverage of the present invention may include vitamins added to the beverage before or after the glucosamine and/or other cartilage health supplement is filtered. In addition to vitamins, such as A, B complex, C, and E, other components possibly may be included in the beverage. These other components may include carbohydrates, protein, fat, minerals, flavorings, and other ingredients.

The preferred method of preparing the beverage containing glucosamine, includes the first step of preparing a solution of glucosamine in water. In a preferred embodiment, the water is filtered. The solution then is passed through a Nominal rated first filter, at a temperature in the preferred range of 10-20° C., or as low as 2° C. and as high as 30° C. The Nominal rated filter is preferably a volumetric fiber matrix, effective to remove approximately 90% of the particles above the rated cut off. The filter allows a relatively long operational period before requiring replacement due to clogging. This filter makes a “rough cut” for large quantities of product, and is suitable for a commercial process. The first filter preferably is manufactured from polypropelene, such as an extruded polypropelene fiber matrix cartridge filter, for example, as commercially available from Siemens under Product No. FCNTF10S5. The first filter has a cut off in the range of 0.2-1.2 microns, with a preferred cut off of 0.5 microns, Nominal. The solution is passed through the first filter at a cross-filter pressure less than or equal to 10 psi to avoid forcing particles through the filter. This step forms a first glucosamine filtrate.

After recovering the first glucosamine filtrate, that filtrate is passed through a second filter rated as Absolute, stopping nearly 100% of particles at the rated cut off and preferably made of a pleated polysulfane membrane, with a cut off in the range 0.3-0.6 microns, with a preferred cut off of 0.45 microns, Absolute. The second filter may be, for example, a Siemens Product No. FCWN510S4 filter. The second filtration step is performed with a cross-filter pressure less than or equal to 10 psi, to reduce driving oversize particles through the second filter. This second filter step also is preferably performed at a temperature in the range of 10-20° C., or at least within the range of 2-30° C.

Both the first filter step and the second filter step are performed with the solution at a pH in the range 1.5-3.5.

In a preferred embodiment, cartridge filters, generally commercially available from Siemens, are used in the inventive process. However, other filters meeting the cut off requirements and which do not produce residues that are incompatible with products for human consumption may also be used.

One aspect of the process of the present invention is that the filter materials, effective pore size and the pressure of the processing, are conducted such that loss of product through the filtration process is minimized. Preferably, the process of the present invention results in loss of less than 1% of initial product.

The final filtrate may be added to a solution into which flavorings, preservatives, and other components such as carbohydrates and/or non-nutrative sweeteners, are mixed together in predetermined amounts. As a dietary supplement solution, the final beverage may have between approximately 0.1% and to approximately 2% by weight joint function enhancing supplement, glucosamine, most preferably fermentation-derived glucosamine hydrochloride. The final, combined solution is adjusted for acidity and, preferably, but not necessarily, chilled to temperatures below ambient and above freezing (approximately 15° and 0° C.),

In a preferred embodiment, water is used for the glucosamine solution that is subjected to the inventive filtration process. However, it may be possible to use other liquid beverage bases. The final beverage may include a juice base, pre-carbonated beverage, or concentrated beverage solutions in the final beverage formulation. In all instances, there is a final pH adjustment just prior to bottling, carbonation, and packaging. A preferred pH range of the final product is at about 3.2. The Brix (measure of soluble solids) and tritratable acidity (TA) are adjusted for each beverage, depending upon the specific composition of the final beverage. Table 1 shows the range of acceptable Brix, TA, and pH for a variety of beverage products of the present invention.

TABLE 1

| | Brix | TA % | pH |
|---|---|---|---|
| Minimum | 0.1 | 0.10 | 3.0 |
| Target | 0.7 | 0.30 | 3.2 |
| Maximum | 1.5 | 0.50 | 4.0 |

The inventive nutritional supplement beverage includes ready-to-drink carbonated beverages and ready-to-drink non-carbonated beverages.

### EXAMPLE 1

The beverage of the present invention containing glucosamine HCl is produced as follows:

A volume of distilled water is aliquoted into a conventional fluid mixer to which an amount of glucosamine HCl is added to water at a final concentration of 18% (weight glucosamine to weight water). The solution is mixed until the glucosamine HCl is solubilized. This solution is passed through an extruded polypropelene fiber matrix cartridge filter (Siemens Product No FCNTF10S5), having a cut off of 0.5 microns, Nominal, at a maximum cross-filter pressure of 10 psi.

The filtrate then recovered from the pre-filter and passed through a pleated polysulfane membrane filter (Siemens Product No. FCWN510S4), having a cut off of 0.45 microns, Absolute, at a maximum cross-filter pressure of 10 psi. Further flavoring, sweeteners, acidifiers, and possibly vitamins, minerals and other joint health enhancing ingredients are added to create the final formula. The Brix, TA, and pH are adjusted to levels consistent to produce a syrup which, when proportioned makes a final beverage within specification. Final syrup is proportioned at 1:4 or 1:5 ratio for the final product.

The final beverage is packaged in containers of various materials, shapes, and sizes, as desired and known to those skilled in the relevant art.

The two-step process may be performed as a batch process. The initial material-to-be-filtered is typically a dark brown concentrated glucosamine solution (typically 1.5 lb glucosamine to 1 gal. of water), with a pH approximately at 1.7. The fibrous first filter (cut off 0.5 microns) removes approximately 90% of the particulates above 0.5 micron. The effluent from that filter is passed to the membrane second filter (cut off 0.45 microns) which removes approximately 99.9% of the remaining particulates. The effluent from the second filter is substantially transparent and ranges from pale yellow to colorless. The process may then be repeated.

Those of skill in the art will recognize that the invention may be embodied in other specific forms without departing from the spirit of essential characteristics thereof. The presently described embodiments are therefore to be considered in all respects as illustrative and not restrictive, the scope of the invention being indicated by the appended claims rather than by the foregoing description. All changes that come within the meaning and range of the equivalency of the claims therefore are intended to be embraced therein.

1. A beverage comprising a substantially clear, water-based solution having a predetermined amount of glucosamine.

2. A beverage according to claim 1 wherein the glucosamine is glucosamine hydrochloride.

3. A beverage according to claim 1 wherein the glucosamine is glucosamine sulfate.

4. A beverage according to claim 1 wherein the beverage is substantially colorless.

5. A beverage according to claim 4 wherein the glucosamine is filtered using a multiple-step filtration process;
whereby the multiple-step filtration process is performed in the temperature range 2-30° C. and at a pH in the range 1.5-3.5;
wherein a first filter step of said two step process includes filtration through a first filter having pore size in the range 0.5-1.2 microns, with a cross-filter pressure less than or equal to 10 psi, and
wherein the second filter step of said multiple-step process includes filtration through a second filter having pore size in the range 0.3-0.6 microns, with a cross-filter pressure less than or equal to 10 psi.

6. A beverage according to claim 5, wherein the first filter is a volumetric fiber matrix filter and the second filter is a membrane filter.

7. A beverage according to claim 6, wherein the first filter comprises an extruded polypropelene fiber matrix and the second filter comprises a pleated polysulfane membrane.

8. A beverage according to claim 5 wherein the glucosamine is glucosamine hydrochloride.

9. A beverage according to claim 6 wherein the glucosamine is fermentation derived glucosamine hydrochloride.

10. A beverage according to claim 5 wherein the glucosamine is glucosamine sulfate.

11. A beverage according to claim 5 wherein the cut off of the first filter is 0.5 microns, Nominal, and the cut off of the second filter is 0.45 microns, Absolute.

12. A method for preparing a substantially clear glucosamine beverage, comprising the steps of:
filtering a water-based glucosamine solution at a temperature in the range 2-30° C. and at a pH in the range 1.5-3.5, in a multiple-step filter process,
wherein a first filter step is through a first filter having a cut off in the range 0.2-1.2 microns, with a cross-filter pressure less than or equal to 10 psi, resulting in a first glucosamine filtrate; and
wherein a second filter step is filtering the first glucosamine filtrate through a second filter having a cut off in the range 0.3-0.6 microns, with a cross-filter pressure less than or equal to 10 psi, resulting in second glucosamine filtrate.

13. The method according to claim 12, wherein the first filter is a volumetric fiber matrix filter and the second filter is a membrane filter.

14. The method according to claim 13, wherein the first filter comprises an extruded polypropelene fiber matrix and the second filter comprises a pleated polysulfane membrane.

15. The method according to claim 12 wherein the second glucosamine filtrate is colorless.

16. The method according to claim 12 wherein the glucosamine is glucosamine hydrochloride.

17. The method according to claim 16 wherein the glucosamine is fermentation-derived glucosamine hydrochloride.

18. The method according to claim 12 wherein the glucosamine is glucosamine sulfate.

19. The method according to claim 12 wherein the pore size of the first filter is 0.5 Nominal microns and the pore size of the second filter is 0.45 microns.

20. The method according to claim 12 comprising the further step of forming the beverage by mixing the second glucosamine filtrate with additional liquid at ambient temperature in the range 2-30° C. and at a pH of in the range 2.5-4.0.
